(19) United States
(12) Patent Application Publication
(10) Pub. No.: US 2013/0232168 A1
(43) Pub. Date: Sep. 5, 2013

(54) Presenting a Temporal Sequence of Geographic Location-Specific Digital Data

(71) Applicants: Lauren Leigh McGregor, (US); Sandra Vlock, (US)

(72) Inventors: Lauren Leigh McGregor, Hamden, CT (US); Sandra Vlock, Stony Creek, CT (US)

(21) Appl. No.: 13/769,309

(22) Filed: Feb. 16, 2013

Related U.S. Application Data
(60) Provisional application No. 61/600,010, filed on Feb. 17, 2012.

(51) Int. Cl. G06F 17/30

(52) U.S. Cl. CPC G06F 17/30241
USPC 707/769

(57) ABSTRACT

Methods and systems for presenting a temporal sequence of geographic location-specific data are disclosed. These include presenting a temporal sequence of geographic location-specific data in response to a single query. A query that includes data specifying a selected geographic location and a time interval is received. In response to the query, at least three temporally distinct times are selected to represent the time interval. At least one visual image data file is selected to represent the selected geographic location at each of the at least three temporally distinct times. At least one additional contextual data file is selected to represent the selected geographic location at each of the at least three temporally distinct times. The selected visual image data files and additional contextual data files are presented in temporal sequence to represent the progression of time at the selected geographic location over the time interval.

### BACKGROUND OF THE DISCLOSURE

1. Technical Field

This invention relates to the presentation of geographic location-specific digital data.

2. Background Information

Digital visual images of specific geographic locations are available in many formats from a number of sources. These data are readily available to represent a single point in time, typically the present time, through various databases. Databases containing such data can be found on the internet, through private networks, or may be loaded onto individual devices. For example, there are many internet databases that present map images for any geographic location. Typically, these map images permit the display of “layers” that provide additional information such as aerial or satellite views of the geographic location, street or feature information, topographic information, and other data sets. Although the data presented through such databases are often collected at different actual times, they are typically presented in a way to reflect a common time, such as the present time.

In addition, visual image data are available to depict changes at selected geographic locations over time. Such visual image data are typically available only for certain preselected locations over preselected time intervals. While such visual image data may be useful, they may not be flexible enough to meet the needs of individuals who want visual image data for different locations or at different time intervals.

### SUMMARY OF THE DISCLOSURE

The present application provides the capability of obtaining from a single system as a result of a single search data that includes visual image data and at least one set of additional contextual attribute data that depicts a specific geographic location over a time interval.

In one embodiment, a method for presenting a temporal sequence of geographic location-specific data in response to a single query includes a step of receiving a query that includes data specifying a selected geographic location and a time interval. In response to the query, at least three temporally distinct times are selected to represent the time interval. At least one visual image data file is selected to represent the selected geographic location at each of the at least three temporally distinct times. At least one additional contextual data file is selected to represent the selected geographic location at each of the at least three temporally distinct times. The selected visual image data files and additional contextual data files are presented in temporal sequence to represent the progression of time at the selected geographic location over the time interval.

In another embodiment, a computer-based system for presenting a temporal sequence of geographic location-specific digital data includes an input device for receiving a query the includes data specifying a selected geographic location and time interval, an output device for presenting visual image data files and additional contextual data files in temporal sequence to represent the progression of time at the selected geographic location over the time interval, a computer-readable storage medium storing information including program routines, and a processing unit coupled to the input device, the output device, and the computer-readable storage medium for controlling the execution of the program routines. The program routines include a user interface and program routines for performing at least the following actions:

(a) selecting at least three temporally distinct times to represent the time interval,

(b) selecting at least one visual image data file for the selected geographic location at each of the at least three temporally distinct times,

(c) selecting at least one additional contextual data file for the selected geographic location at each of the at least three temporally distinct times.

### BRIEF DESCRIPTION OF THE DRAWINGS

FIG. 1 is a schematic of a computer-based system for presenting a temporal sequence of geographic location-specific digital data.

FIG. 2 is a flowchart of a method for presenting a temporal sequence of geographic location-specific digital data.

### DETAILED DESCRIPTION OF THE EMBODIMENTS

During the course of research into a specific geographic location, there is often a desire to obtain visual images of the specific geographic location over a selected time interval. This desire may be driven by a variety of needs, such as the desire for basic information about the specific geographic location, to provide a historical context for certain endeavors associated with the specific geographic location, or for other purposes associated with the specific geographic location. The types of visual images sought may include map images, overhead images, such as aerial images or satellite images, images of physical improvements, images that depict land use, or other images associated with the specific geographic location. The images may be still or movie images stored in any convenient format, for example, JPEG (joint photographic experts group format), JFIF (JPEG file interchange format), Exif (exchangeable image file format), TIFF (tagged image file format), RAW (raw image format), DN (digital negative format), PNG (portable network graphics format), GIF (graphics interchange format), BMP file format (Windows bitmap format), PPM (portable pixmap format), PGM (portable graymap format), PBM (portable bitmap format), PNM format (portable any map format), MPEG (motion picture experts group format), MOV (Quicktime movie format), WMV (Windows Media Video) or any other existing or yet to be developed format.

While such selections of visual images for a selected geographic location may be sufficient for certain purposes, we disclose a system and method for supplementing visual imagery of a selected geographic location with additional data to provide context for changes that occur at the geographic location over time. The additional data present one or more contextual attributes such as scientific, social, cultural, artistic, historical, humanistic, religious, or other attributes or a combination of any such or other attributes, which we refer to generically as “additional contextual attribute data.” The additional contextual attribute data may exist as images or may be in different formats such as audio files or other files that provide contextual attribute data. Image files may be stored as describe in the preceding paragraph. Audio files may be stored in any convenient format, for example, WAV or any other existing or yet to be developed format. Any other data files that may be associated with the geographic location over time may be of interest as additional contextual attribute data.

By providing a rich set of additional contextual attribute data associated with a specific geographic location for a time interval selected by a user or system, we provide a user with multiple dimensions of data with which to interpret changes at the specific geographic location over the selected time interval. One benefit of the disclosed system and method is to build a deeper understanding and appreciation for the impact of changes at a selected geographic location over the selected time interval. We recognize, though, that there are many uses for such a rich data set and we in no way intend the present disclosure to be limited to any particular context or any particular use.

While much of the data related to a selected geographic location are available from a variety of sources, it is not possible with prior systems and methods to generate on demand multiple time sequenced visual image and additional contextual attribute data files for a selected geographic location from a single system as a result of a single search. The disclosed system and method address that problem by providing a means for accessing a variety of data associated with a selected geographic location with a single search on a single system.

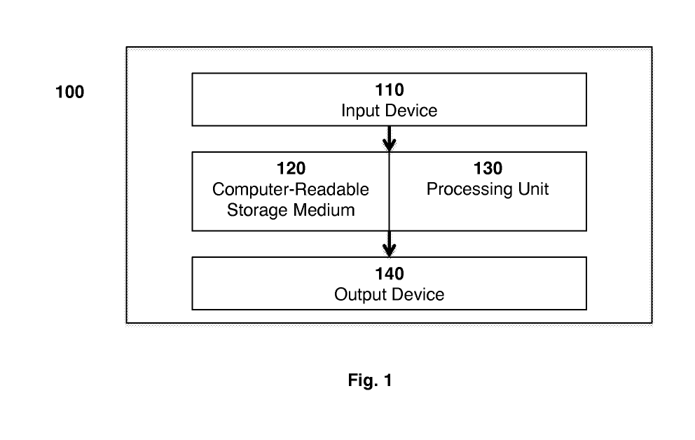

As shown in FIG. 1, a computer-based system 100 for presenting a temporal sequence of geographic location-specific digital data includes an input device 110, a computer-readable storage medium 120, a processing unit 130, and an output device 140. Such a system 100 may be implemented on any device capable of supporting the appropriate input 110 and output 140 devices, computer-readable storage medium 120, and processing unit 130. In a first embodiment, the system 100 is implemented on a server, centralized device, cluster of devices (including cloud computing devices) or other devices known in the art to provide communication with remote or mobile devices or users over the internet using a web browser or other program that implements an internet protocol or other communication pathways and/or protocols known in the art. This embodiment may include computer-readable storage medium 120 that permits central storage of a core group of data files that will generate at least a portion of search results along with a user interface and program routines that perform at least the actions of

(a) selecting at least three temporally distinct times to represent the time interval,

(b) selecting at least one visual image data file for the selected geographic location at each of the at least three temporally distinct times, and

(c) selecting at least one additional contextual data file for the selected geographic location at each of the at least three temporally distinct times as further described below.

In a second embodiment, the system 100 may be implemented on a remote or mobile device, such as a computer, smart telephone, pad device or other device that is in communication with one or more centralized data bases that store a core group of data files that will generate at least a portion of search results. In a third embodiment, the system 100 may be implemented on a remote or mobile device, such as a computer, smart telephone, pad device or other device that includes sufficient computer-readable storage medium 120 to store data files that will generate some or all of the search results. In this embodiment, the remote or mobile device may not be in communication with any other device, in which case the search results will be generated solely from data stored on the remote or mobile device and any additional computer-readable storage medium that is attached to the remote devise. If the remote device of the third embodiment is in communication with another device, it may use the other device with which it is in communication to supplement the data stored on the remote or mobile device, in which case, the search results may be generated from a combination of data stored on the remote or mobile device and data stored in one or more additional locations. Persons skilled in the art will know how to implement these embodiments in view of the present disclosure and may know of additional embodiments that may be useful with the present disclosure. As a result, this recitation of embodiments is exemplary only and is not intended to limit in any way the breadth of the present disclosure.

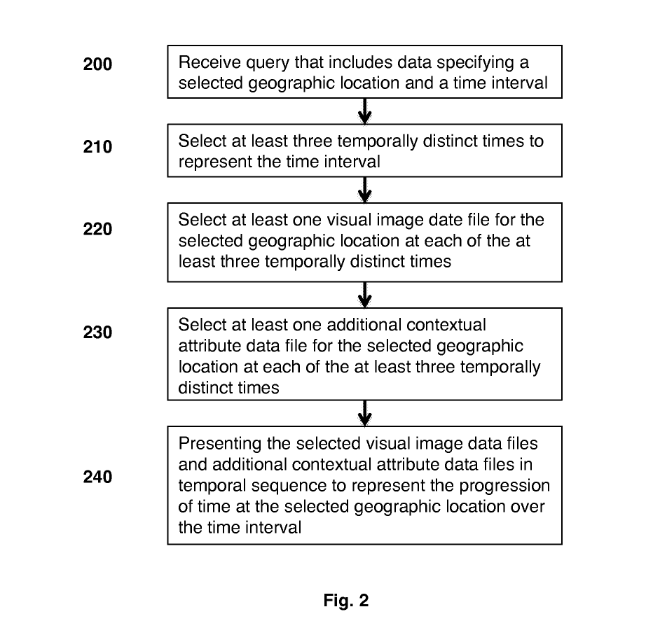

The system 100 described above can be used to present a temporal sequence of geographic location-specific digital data in response to a single query. As shown in FIG. 2, the system 100 receives a query 200 that includes at least data specifying a geographic location and a time interval. The time interval may be either expressly entered or may be provided by the system 100 as a system default. The query may be entered by any means known to one skilled in the art. The location data may take any convenient format, such as a street address, map coordinates, or other geographic descriptor. The location data may then be converted to a location index that is used to access geographically indexed data. Similarly, a time interval may be entered by any means known to one skilled in the art. Alternately, the system 100 may provide for a default time interval that starts at the present time and extends back in time or forward in time for a preselected time. For example, the default time interval may start at the present time and extend back in time for forty years. Of course, any other default time interval may be chosen or any other time interval may be entered into the system 100. Alternately, the default time interval may start at the present time and extend forward in time for forty years or some other future end point. Selection of data to represent future time intervals is discussed later in this disclosure.

In response to the query that includes data specifying a selected geographic location and a time interval, the system 100 selects in step 210 at least three temporally distinct times to represent the time interval. By temporally-distinct times, we mean times that are sufficiently distinct that one skilled in the art could not reasonably use them to represent the same time. The degree of distinctness may vary based on the richness of the underlying data set and the speed with which changes have occurred to a relevant attribute. For example, data that depict images of undeveloped land may require a significantly longer interval between the temporally distinct times than data that depict images of clothing or costume associated with a geographic location. Similarly data that depict music associated with a geographic location may only require a relatively short interval between the temporally distinct times. In any case, the interval between the temporally-distinct times can be set either by the system 100 or by an external input or a combination of the two. In addition, the number of temporally-distinct times selected may be set either by the system 100 or by an external input or a combination of the two.

Once the temporally distinct times have been selected, the system 100 selects in step 220 at least one visual image data file for the selected geographic location at each of the at least three temporally distinct times. The visual image data file may include overhead images, landscape or building images, images of clothing, costume, art, etc. associated with the selected geographic location at an identified time or any other image file now known or later developed associated with the selected geographic location at an identified time. The visual image data files may reflect the past, present, or future times. Visual image data files that reflect past or present times may be files based on actual data or data created by a model or simulation to project an attribute at a past or present time. Visual image data files that reflect future times will be based on data created by a model or simulation to project an attribute at a future time. The models or simulations used to project a visual image data file at a past, present, or future time may be of any type that a person of ordinary skill would know to be appropriate for such use. Such models or simulations may be typical of models or simulations used for scientific projection of climate change, geologic movement or other physical or biological changes over time, such as computer-based land use models, climate models, geophysical models, and any other existing or yet to be developed models or simulations that a person of ordinary skill would know to be appropriate for such use. In addition, the models or simulations may be typical of those used for private forecasting, gaming, entertainment or other purposes, whether popular circulation or used for propriety or non-public purposes and any other existing or yet to be developed models or simulations that a person of ordinary skill would know to be appropriate for such use.

Also, once the temporally distinct times have been selected, the system 100 selects in step 230 at least one additional contextual attribute data file to represent at least one additional contextual attribute of the selected geographic location at each of the at least three temporally distinct times. The additional contextual attributes of the selected geographic location may include overhead images, landscape or building images, images of clothing, costume, art, etc. associated with the selected geographic location at an identified time, audio files associated with the selected geographic location at an identified time, or any other file now known or later developed associated with the selected geographic location at an identified time. The additional contextual attribute data files may reflect the past, present, or future times. Additional contextual attribute data files that reflect past or present times may be files based on actual data or data created by a model or simulation to project an attribute at a past or present time. Additional contextual attribute data files that reflect future times will be based on data created by a model or simulation to project an attribute at a future time. The models or simulations used to project an additional contextual attribute at a past, present, or future time may be of any type that a person of ordinary skill would know to be appropriate for such use. Such models or simulations may be typical of models or simulations used for scientific projection of climate change, geologic movement or other physical or biological changes over time, such as computer-based land use models, climate models, geophysical models, and any other existing or yet to be developed models or simulations that a person of ordinary skill would know to be appropriate for such use. In addition, the models or simulations may be typical of those used for private forecasting, gaming, entertainment or other purposes, whether popular circulation or used for propriety or non-public purposes and any other existing or yet to be developed models or simulations that a person of ordinary skill would know to be appropriate for such use.

Following selection of the visual image data files and additional contextual attribute data files, the system 100 presents in step 240 selected visual image data files and additional contextual attribute data files are presented in temporal sequence to represent the progression of time at the selected geographic location over the time interval. Preferably, the visual image data files are linked and presented as a seamless presentation over time. The additional contextual attribute data files may be overlaid, interleaved, or otherwise presented with the visual image data files in a manner that provides context to the presentation of the visual image data files. The rate at which the visual images are presented may be user selected or determined by the system to present the visual images over a predetermined time, for example over a time of two minutes or other time deemed to be appropriate. One skilled in the art will know how to select a time that makes sense for the presentation. Optionally, the user may be provided the option of stopping the presentation to display a single image or to step through the presentation image by image rather than as a seamless display.

Another option would be to display the information as a “spark line” as is known in the art. For example, a person of ordinary skill would know how to use the methods discussed by Edward Tufte to present the data that are the subject of this disclosure in the sort of spark line that Tufte contemplates in his book Beautiful Evidence (Graphics Press LLC, 2006; available through www.edwardtufte.com).

All the data to be presented in accordance with this disclosure are assembled at the time of a query as a result of the query. The data sources used to assemble the data may be any data available to the system through a dynamic search (for example, through an internet search conducted at the time of the query). Alternately, the data sources may be constrained to certain sources that contain data of known quality and content. Using such constrained data, which may also be referred to as curated data, has the benefit of presenting high quality, verified data rather than random data or data of unverified validity and/or quality.

Optionally, users may be permitted to upload their own geographically and temporally tagged data to the system to supplement data sources already available to the system. Retrieval of such user-provided data can be limited to the user, other individuals or groups specified by the user, or made available for unlimited use by all users. Alternately, the user-provided data may be reviewed by a system manager for inclusion within a set of constrained or curated data.

As contemplated the basic presentation of data by the system will include at least one set of visual images for the selected geographic location supplemented by at least one set of contextual attribute data. Of course, multiple sets of contextual attribute data may be presented in any format that can be envisioned by a person skilled in the art. For example, the additional sets of contextual attribute data may be temporally interleaved with the other data presented. Alternately, the additional sets of contextual data may be available as additional data “layers” that may be presented as a result of a user selection to display specific additional data “layers.”

One way of thinking about the system 100 of the present disclosure is to consider it a system for presenting a visual and or audio representation of the passage of time at a selected geographic location. Another perspective is to view the system 100 of the present disclosure as creating a visual record of the earth's surface supplemented by data to present additional contextual attributes over a selected time interval. This view could be termed creating a “temporal echo.” The supplemental contextual attribute data may be presented as event based data, attribute based data, cultural based data, or data presented on some other basis that a person skilled in the art would know how to select for a given time interval.

The system 100 may generate data to display on its own display device, a remote display in communication with the system, or in some other format. For example, the system 100 may generate data in a format that interfaces with services provided by others, such as social media services.

These and other variations of the preferred and alternate embodiments and methods are provided by the present disclosure. The embodiments described have been presented for purposes of illustration and are not intended to be exhaustive or limiting. Many variations and modifications are possible in light of the teachings of this disclosure. The disclosure is limited only by the following claims.

We claim:

1. A method for presenting a temporal sequence of geographic location-specific digital data in response to a single query comprising the steps of:
(a) receiving a query that includes data specifying a selected geographic location and a time interval,
(b) in response to the query, selecting at least three temporally distinct times to represent the time interval,
(c) selecting at least one visual image data file for the selected geographic location at each of the at least three temporally-distinct times,
(d) selecting at least one additional contextual data file for the selected geographic location at each of the at least three temporally-distinct times, and
(e) presenting the selected visual image data files and additional contextual data files in temporal sequence to represent the progression of time at the selected geographic location over the time interval.

2. The method of claim 1, wherein the requested time interval is a system generated default time interval.

3. The method of claim 1, wherein the requested time interval is received as part of the query of step (a).

4. The method of claim 1, wherein the at least one visual image data file is selected from the group consisting of still image files and video image files.

5. A computer-based system for presenting a temporal sequence of geographic location-specific digital data, comprising:
(a) an input device for receiving a query the includes data specifying a selected geographic location and time interval,
(b) an output device for presenting visual image data files and additional contextual data files in temporal sequence to represent the progression of time at the selected geographic location over the time interval,
(c) a computer-readable storage medium storing information including program routines including
(i) a user interface
(ii) program routines for performing at least the following actions
(iia) selecting at least three temporally distinct times to represent the time interval
(iib) selecting at least one visual image data file for the selected geographic location at each of the at least three temporally distinct times
(iic) selecting at least one additional contextual data file for the selected geographic location at each of the at least three temporally distinct times
(d) a processing unit coupled to the input device, the output device, and the computer-readable storage medium for controlling the execution of the program routines.

6. The computer-based system of claim 5, wherein the system is implemented on a mobile device selected from the group consisting of portable computers, cellular telephones, and pad computing devices.
